(19) United States
(12) Patent Application Publication
(10) Pub. No.: US 2021/0215537 A1
(43) Pub. Date: Jul. 15, 2021

(54) COMPOSITE MULTISPECTRAL RAMAN SPECTROSCOPY METHOD AND DEVICE

(71) Applicants: UNIVERSITE DE BORDEAUX, BORDEAUX (FR); INSTITUT POLYTECHNIQUE DE BORDEAUX, TALENCE (FR); CENTRE NATIONAL DE LA RECHERCHE SCIENTIFIQUE, PARIS (FR)

(72) Inventors: Nicolas DAUGEY, BORDEAUX (FR); Thierry BUFFETEAU, TALENCE (FR); Jean-Luc BRUNEEL, SAINT SELVE (FR); Vincent RODRIGUEZ, CESTAS (FR)

(21) Appl. No.: 17/055,295

(22) PCT Filed: May 13, 2019
(86) PCT No.: PCT/FR2019/051076

§ 371 Date: Nov. 13, 2020

(30) Foreign Application Priority Data
May 16, 2018 (FR) 1854096

(51) Int. Cl. G01J 3/44; G01J 3/02; G01J 3/45; G01J 3/10

(52) U.S. Cl. CPC G01J 3/4412; G01J 3/0205; G01J 2003/102; G01J 3/45; G01J 3/10; G01J 3/0224

(57) ABSTRACT

Disclosed is a Raman spectroscopy device including a source system generating a first excitation light beam at a first excitation frequency, a spectral separation system, a detection system in an observation spectral range, and a calculator generating a first part of the Raman scattering spectrum in a first Raman spectral range extending between a first relative wave number and a second relative wave number. The source system is adapted to generate a second excitation light beam at a second excitation frequency different from the first excitation frequency, the computer generating a second part of the Raman scattering spectrum in a second Raman spectral range, expressed as wave number as a function of the same observation spectral range, the second spectral range extending between a third relative wave number and a fourth relative wave number. Also disclosed is a Raman spectroscopy method.

### TECHNICAL FIELD TO WHICH THE INVENTION RELATES

The present invention generally relates to the field of Raman spectrometry. It more particularly relates to Raman spectrometry device and method.

### TECHNOLOGICAL BACKGROUND

The observation of spectral domains towards the high wavenumbers by Raman spectrometry (it is talked about high-frequency Raman spectrometry) generally requires settings involving the displacement of the optical components or the use of other optical components or, as the case may be, of more suitable detection systems increasing the complexity and hence the cost of the device. These conventional Raman spectrometry systems are generally limited in spectral resolution and/or in the observed spectral domains.

According to the known devices, it is possible to obtain a good spectral resolution by restricting the spectral domain. The use of a spectrometer with a mobile dispersive system then makes it possible to sound successively the whole spectral domain. Generally, this configuration induces a decrease of detectivity of the detection system at the very high wavenumbers (higher than 4000 cm⁻¹).

Another known configuration consists in choosing a fixed spectral separation system for the whole spectral domain but with a lower spectral resolution.

Still another configuration consists in using a mask comprising a set of slots in front of the detection system to refine the resolution, and in successively shifting this mask to resolve the spectrum over the whole spectral domain.

This technology applies to a Raman spectrometry device, for which it is desirable to extend the spectral domain and/or to increase the spectral resolution, while maintaining the compactness, the simplicity, and hence the cost and solidity thereof, but also the reproducibility thereof.

### OBJECT OF THE INVENTION

In order to remedy the above-mentioned drawbacks of the state of the art, the present invention proposes a Raman spectrometry device.

More particularly, it is proposed according to the invention a Raman spectrometry device for characterizing a sample, the device comprising a source system generating a first incident excitation light beam at a first excitation wavelength, a spectral separation system receiving a first scattered light beam formed by scattering of said first incident excitation light beam on the sample and spectrally separating said first scattered light beam, a detection system making it possible to record a first Raman signal associated with said first scattered light beam and detected in an observation spectral range expressed in wavelength extending between a first observation wavelength and a second observation wavelength, a calculator receiving the first Raman signal from said detection system and generating a first Raman spectrum part as a function of the Raman displacement in a first Raman spectral domain expressed in relative wavenumber, said first Raman spectral domain extending between a first relative wavenumber that is function of the first excitation wavelength and the first observation wavelength and a second relative wavenumber that is function of the first excitation wavelength and the second observation wavelength.

According to the invention, said source system is adapted to generate at least one second incident excitation light beam at a second excitation wavelength, said second excitation wavelength being different from the first excitation wavelength, said spectral separation system being adapted to receive a second scattered light beam formed by scattering of said second incident excitation light beam on the sample and to spectrally separate said second scattered light beam, said detection system being adapted to detect and record a second Raman signal associated with said second scattered light beam in the same observation spectral range expressed in wavelength, said calculator being adapted to measure the second Raman signal and to generate a second Raman spectrum part as a function of the Raman displacement in a second Raman spectral domain expressed in relative wavenumber, said second Raman spectral domain extending between a third relative wavenumber that is function of the second excitation wavelength and the first observation wavelength and a fourth relative wavenumber that is function of the second excitation wavelength and the second observation wavelength, the second Raman spectral domain being different in relative wavenumber from the first Raman spectral domain, the first Raman spectrum part and the second Raman spectrum part being intended to be combined together to reconstitute a Raman scattering spectrum over a spectral domain that is extended in relative wavenumber and/or that has an increased spectral resolution in the first and/or second Raman spectral domain.

Advantageously, in the configuration of the invention, different excitation wavelengths are used in combination without thereby modifying the detection filter(s). A relatively narrow observation spectral range then allows obtaining as many different Raman spectrum parts over different spectral domains expressed in relative wavenumber as there are excitation wavelengths, which then make it possible to constitute a set of Raman spectrum parts or to reconstitute a Raman spectrum that is extended and/or that has an increased spectral resolution in relative wavenumber. The compactness of the spectrometry device and the simplified use thereof are then improved because only the excitation wavelengths are modified, no additional setting being required.

Other non-limitative and advantageous features of the Raman spectrometry device according to the invention, taken individually or according to all the technically possible combinations, are the following:
the source system is adapted to generate a plurality of excitation light beams at a plurality of excitation wavelengths;
the source system comprises a plurality of monochromatic laser sources, an optical frequency-tunable laser source and/or a source generating several selectable or spatially separable monochromatic excitation wavelengths;
the source system comprises a continuous or pulsed laser source;
it is also provided at least one device for polarizing the excitation light beam between the source system and the sample, said polarization device being adapted to polarize the first incident excitation light beam according to at least two different polarization states, for example orthogonal to each other, and, respectively, the second incident excitation light beam according to at least two different polarization states, for example orthogonal to each other;
it is also provided a polarization analyser arranged between the sample and the detection system, the polarization analyser being adapted to polarization analyse and/or separate the first scattered light beam and, respectively, the second scattered light beam;
the calculator is configured to hold the first Raman scattering spectrum part and the second Raman scattering spectrum part and to constitute a set of Raman spectrum parts or to combine the first Raman spectrum part and the second Raman spectrum part and to reconstitute a Raman spectrum that is extended and/or that has an increased spectral resolution in relative wavenumber;
the calculator is adapted to generate a first, respectively second, hyper Raman scattering spectrum part in a first, respectively second, hyper Raman displacement spectral domain expressed in relative wavenumber, wherein the first relative wavenumber is equal to the difference between a product of an integer n and of the first excitation wavenumber and the first observation wavenumber, the second relative wavenumber is equal to the difference between a product of the integer n and of the first excitation wavenumber and the second observation wavenumber, the third relative wavenumber is equal to the difference between a product of the integer n and of the second excitation wavenumber and the first observation wavenumber, the fourth relative wavenumber is equal to the difference between a product of the integer n and of the second excitation wavenumber and the second observation wavenumber, the integer multiple n being higher than or equal to two;
it is also provided a detection filter configured to cut-off the first excitation wavelength and/or the second excitation wavelength;
the detection filter comprises at least one high-pass filter, one low-pass filter or one band-pass filter, or a combination of said filters;
the spectral separation system comprises a spectrometer based on diffraction grating(s), prism(s) and/or grism(s) or a spectrometer comprising a combination of diffraction grating(s) and/or prism(s) and/or grism(s);
the spectral separation system comprises an interferential filter and/or an interferometer;
the detection filter is fixed; and
the detection system comprises a single-channel detector or a one-dimensional linear detector or a two-dimensional array detector.

The invention also proposes a Raman spectrometry method comprising the following steps:
generation of a first incident excitation light beam at a first excitation wavelength by a source system;
spectral separation of a first scattered light beam formed by scattering of the first incident excitation light beam on a sample;
recording of a first Raman signal associated with the first scattered light beam, detected in an observation spectral range expressed in wavelength extending between a first observation wavelength and a second observation wavelength;
calculation of a first Raman spectrum part as a function of the Raman displacement in a first Raman spectral domain expressed in relative wavenumber, said first Raman spectral domain extending between a first relative wavenumber that is function of the first excitation wavelength and the first observation wavelength and a second relative wavenumber that is function of the first excitation wavelength and the second observation wavelength;
generation of at least one second incident excitation light beam at a second excitation wavelength by the source system, said second excitation wavelength being different from the first excitation wavelength;
spectral separation of a second scattered light beam formed by scattering of the second incident excitation light beam on the sample;
recording of a second Raman signal associated with the second scattered light beam, detected in the same observation spectral range expressed in wavelength;
calculation of a second Raman spectrum part as a function of the Raman displacement in a second Raman spectral domain expressed in relative wavenumber, said second Raman spectral domain extending between a third relative wavenumber that is function of the second excitation wavelength and the first observation wavelength and a fourth relative wavenumber that is function of the second excitation wavelength and the second observation wavelength, the second Raman spectral domain being different in relative wavenumber from the first Raman spectral domain; and
combination of said first Raman scattering spectrum part and said second Raman scattering spectrum part to reconstitute a Raman scattering spectrum over a spectral domain that is extended in relative wavenumber and/or that has an increased spectral resolution in the first and/or second Raman spectral domain.

### DETAILED DESCRIPTION OF AN EXEMPLARY EMBODIMENT

The following description in relation with the appended drawings, given by way of non-limitative examples, will allow a good understanding of what the invention consists of and of how it can be implemented.

In the appended drawings:

FIG. 1 proposes a schematic representation of the different elements of a Raman spectrometry device according to the invention;

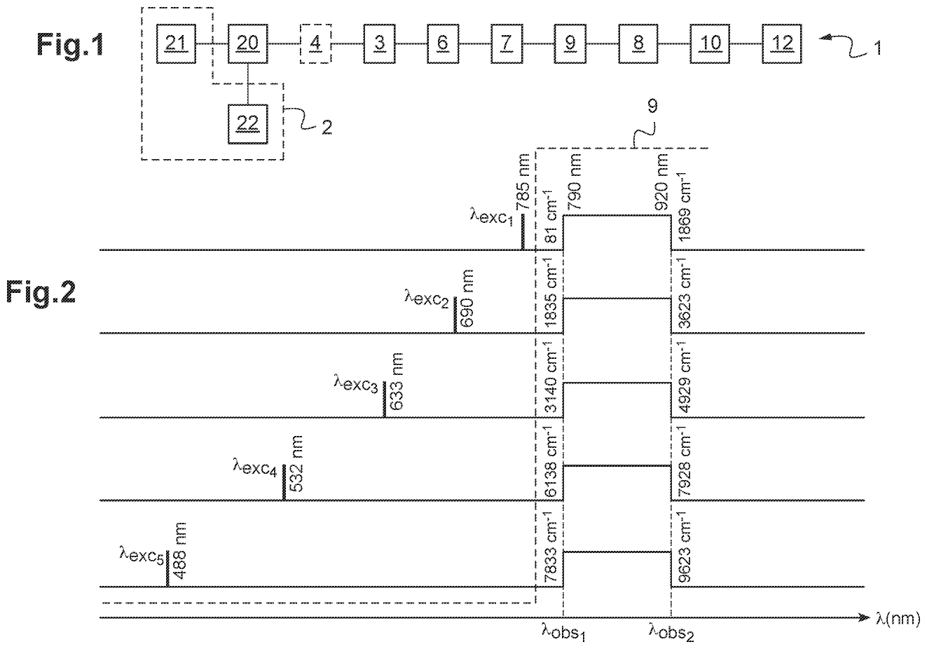

FIG. 2 proposes an example of instrumental configuration of the Raman spectrometry device according to the invention;

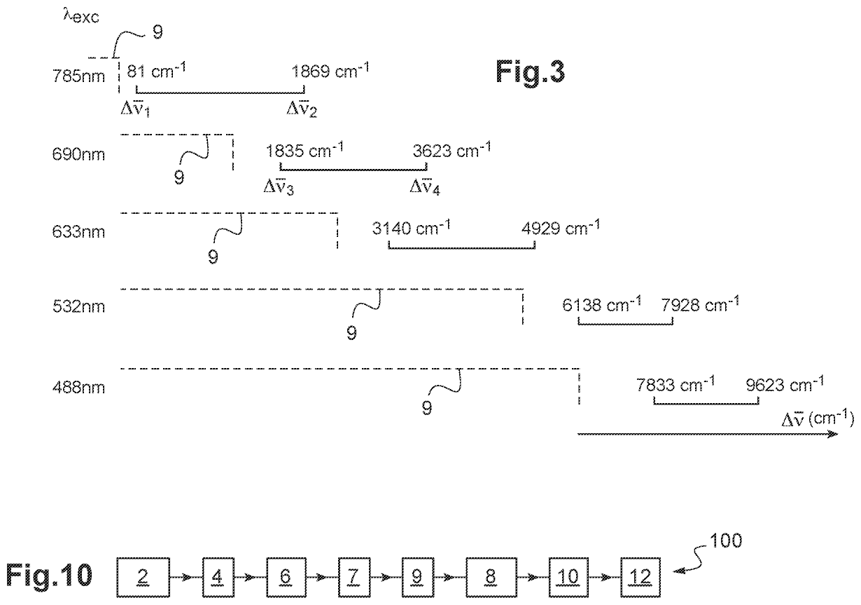

FIG. 3 proposes a schematic representation of the spectral domains obtained in relative wavenumber for several proposed excitation wavelengths;

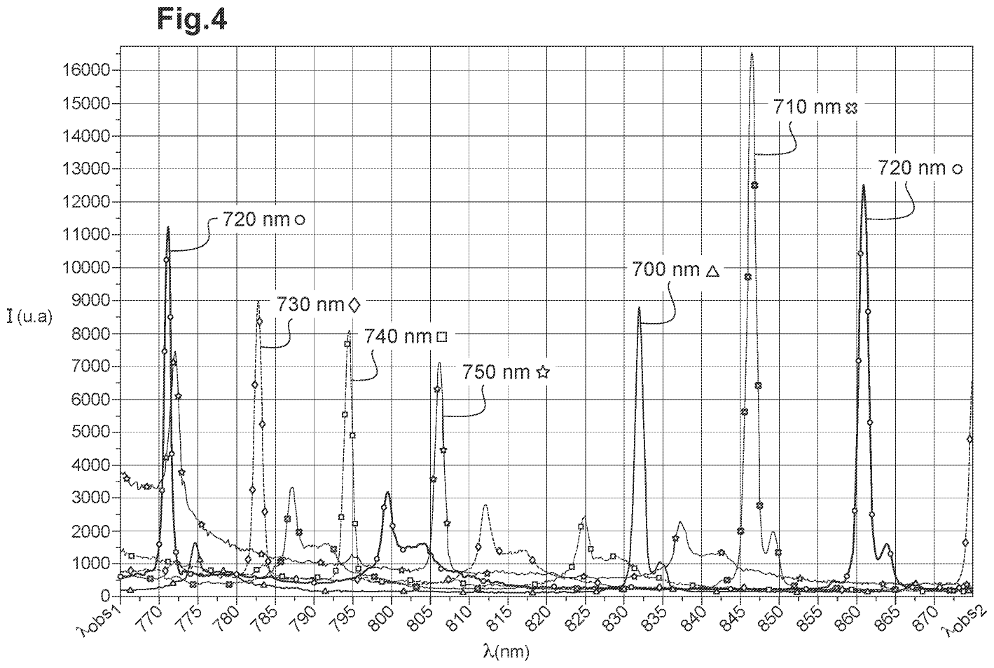

FIG. 4 shows an example of several Raman scattering spectrum parts in Stokes configuration, acquired at several excitation wavelengths and represented as a function of the observation wavelength;

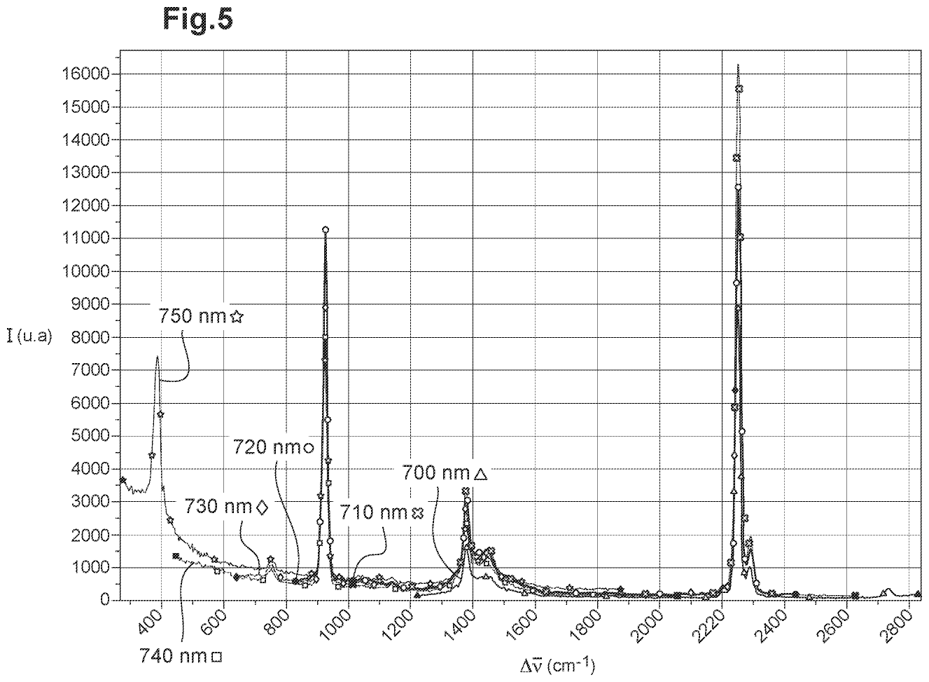

FIG. 5 shows an example of Raman scattering spectrum parts in Stokes configuration, calculated from the spectrum parts of FIG. 4 and represented as a function of the Raman displacement expressed in relative wavenumber;

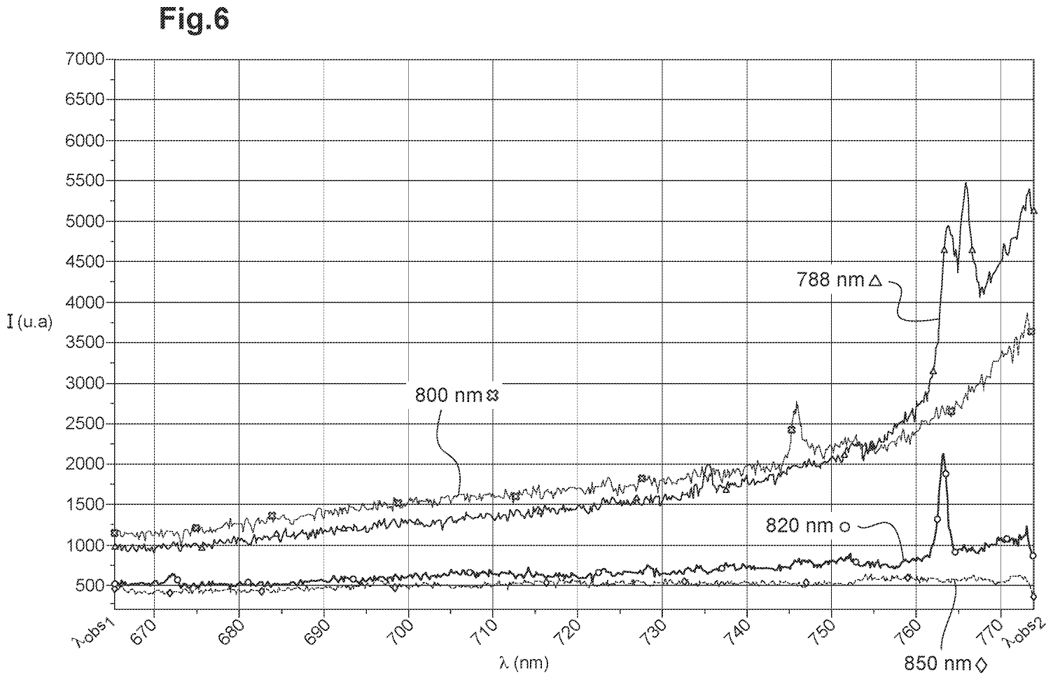

FIG. 6 shows an example of several Raman scattering spectrum parts in anti-Stokes configuration, acquired at several excitation wavelengths and represented as a function of the observation wavelength;

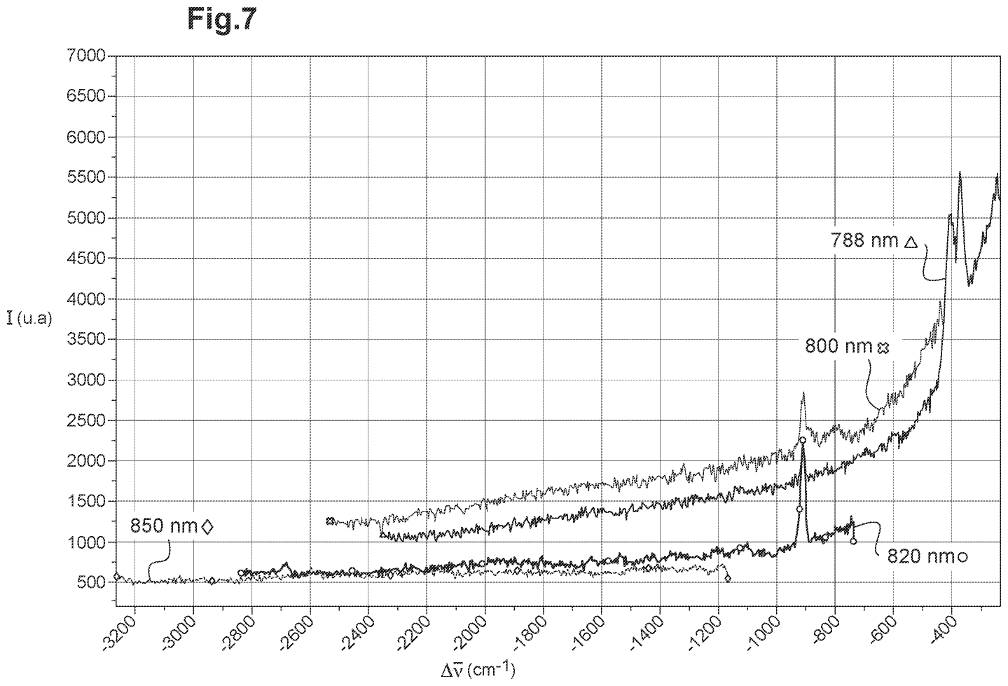

FIG. 7 shows the examples of Raman scattering spectrum parts in anti-Stokes configuration, calculated from the spectrum parts of FIG. 6 acquired at different excitation wavelengths and represented as a function of the Raman displacement expressed in relative wavenumber;

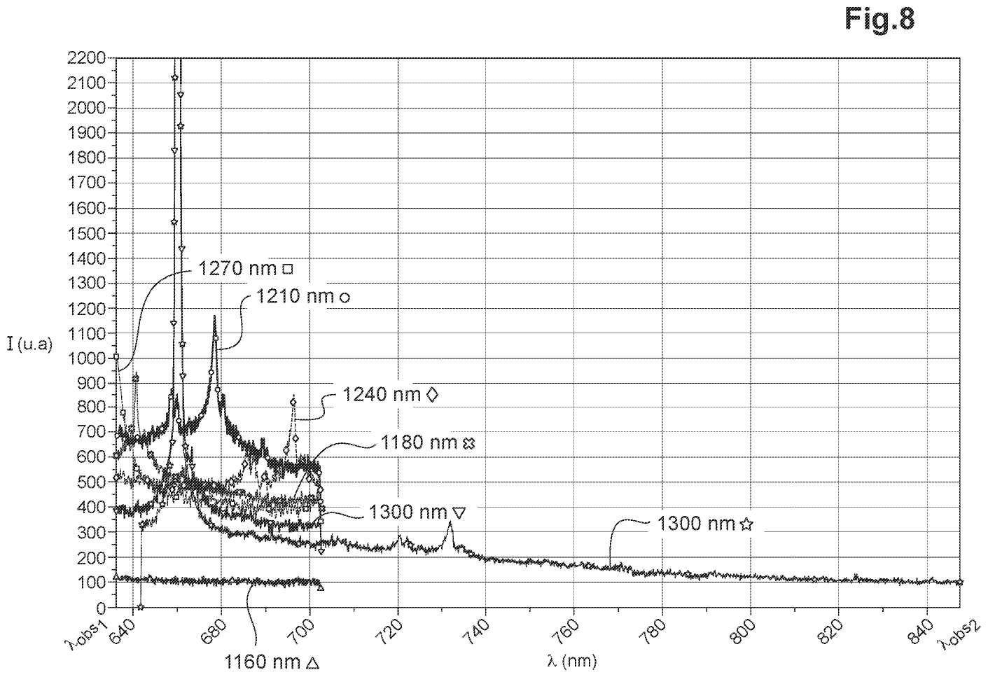

FIG. 8 shows an example of hyper Raman scattering spectrum parts in Stokes configuration, acquired at different excitation wavelengths and represented as a function of the observation wavelength;

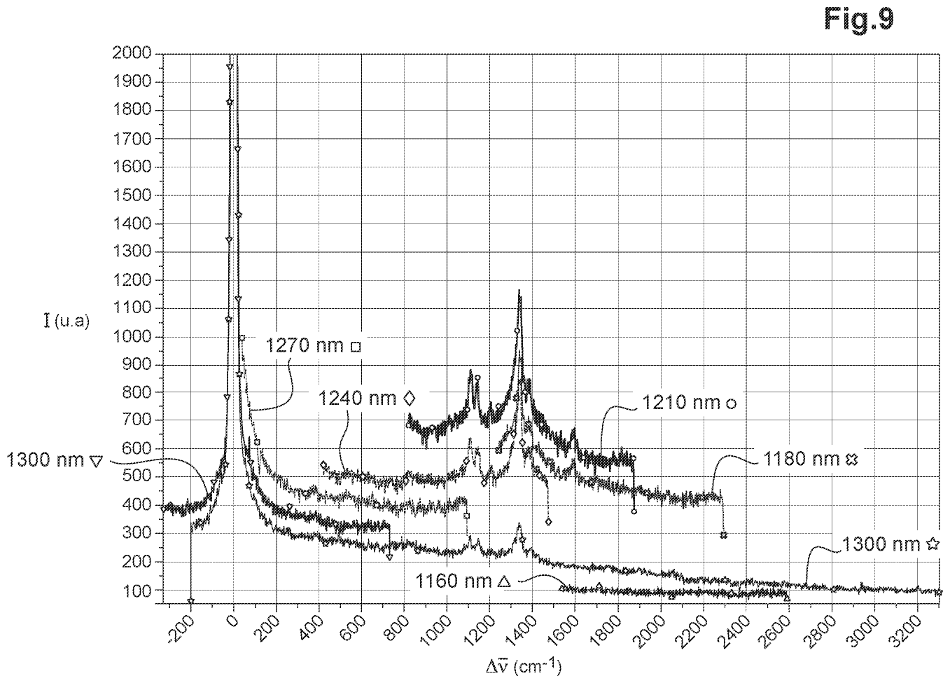

FIG. 9 shows the examples of hyper Raman scattering spectrum parts in Stokes configuration, calculated from the spectrum parts of FIG. 8 and represented as a function of the Raman displacement expressed in relative wavenumber;

FIG. 10 proposes another schematic representation of the different elements of a Raman spectrometry device according to the invention;

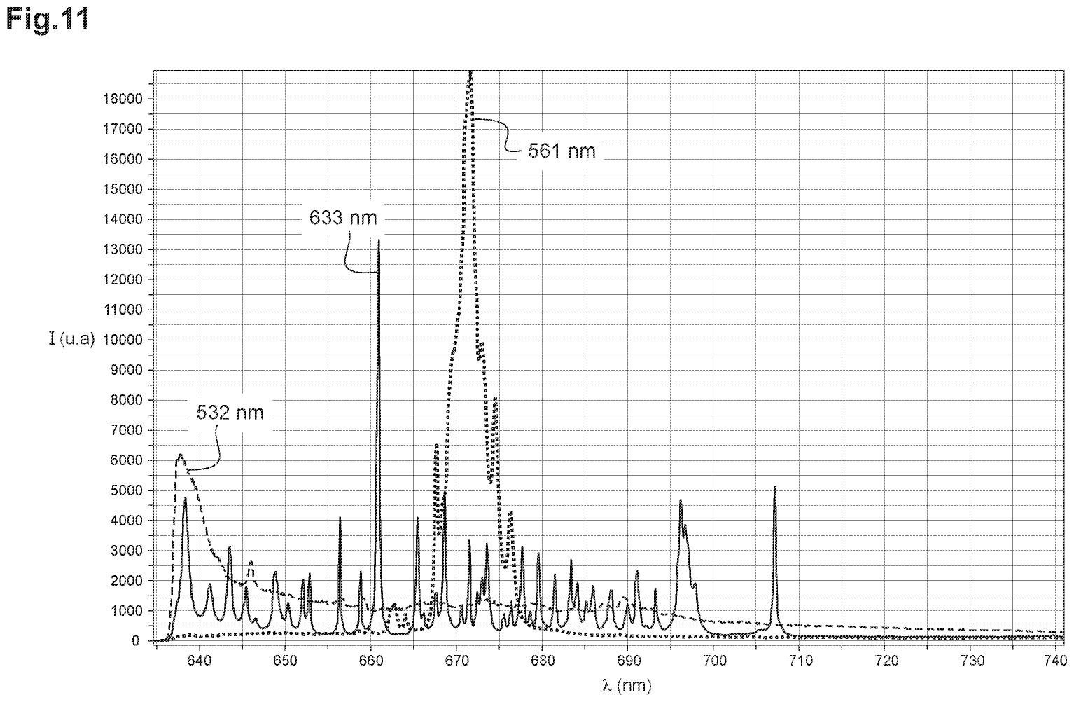

FIG. 11 shows an example of several Raman scattering spectrum parts, acquired at several excitation wavelengths and represented as a function of the observation wavelength;

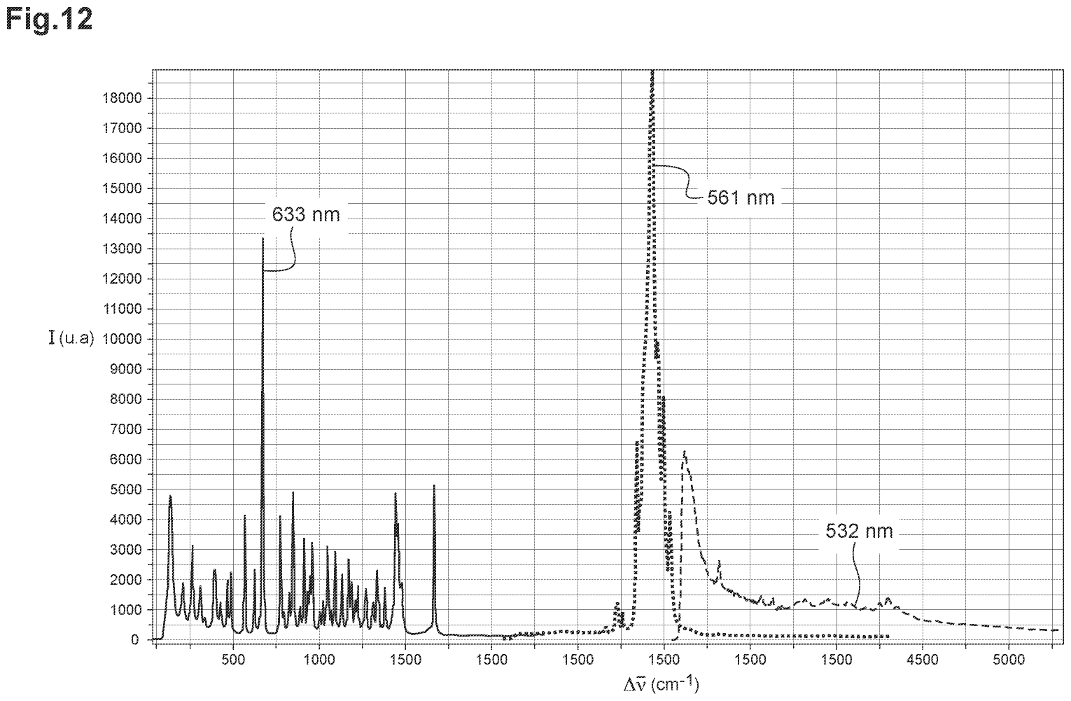

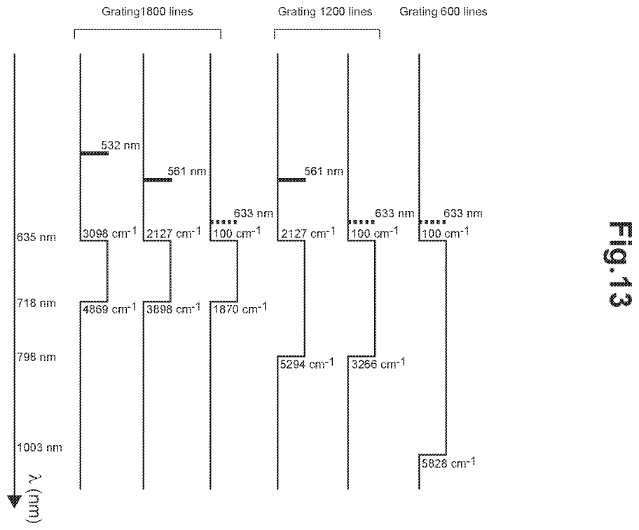

FIG. 12 shows an example of Raman scattering spectrum parts, calculated from the spectrum parts of FIG. 11 and represented as a function of the Raman displacement expressed in relative wavenumber;

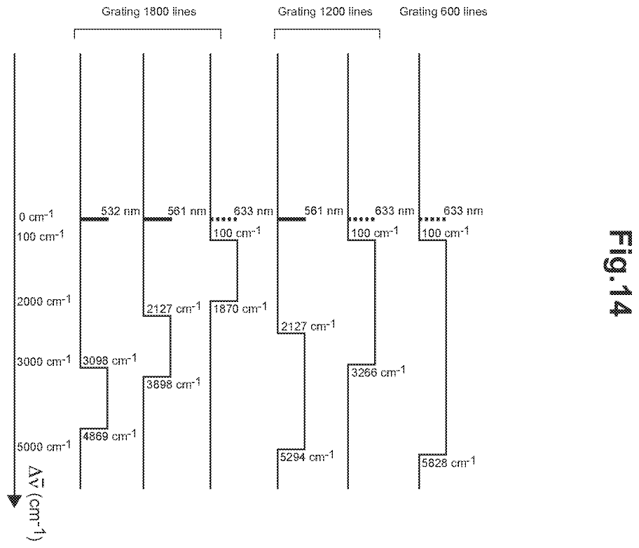

FIG. 13 proposes a schematic representation of the spectral domains obtained in relative wavenumber for several excitation wavelengths proposed and several spectral separation systems, the abscissa axis being in wavelength; and

FIG. 14 proposes a schematic representation of the spectral domains obtained in relative wavenumber of FIG. 13 for several excitation wavelengths proposed and several spectral separation systems, the abscissa axis being in relative wavenumber.

In the whole description, the terms “wavelength” and “wavenumber” will be used, the relation between the two terms being described by the following formula (1):

$$\overline{v} = \frac{1 {0}^{7}}{λ} \qquad ( 1 )$$

where v̅ corresponds to the wavenumber, expressed in cm⁻¹, and λ corresponds to the wavelength, expressed in nm.

The Raman effect consists in the inelastic scattering of photons by a material, a solution or a gas. In the whole description, the Raman displacement or Raman shift is always expressed in wavenumber difference, herein denoted Δv̅_{Raman}. The Raman displacement is equal to the difference between a wavenumber corresponding to the wavelength of the incident excitation light beam and a wavenumber corresponding to the wavelength in an observation spectral range. The Raman displacement in wavenumber, called “relative wavenumber” in the present document, of the excitation with respect to the observation, is given by the following formula:

$$Δ {\overline{v}}_{R a m a n} = {\overline{v}}_{e x c} - {\overline{v}}_{o b s} = ( \frac{1}{{λ}_{e x c}} - \frac{1}{{λ}_{o b s}} ) \times 1 {0}^{7} ( c {m}^{- 1} ) \qquad ( 2 )$$

where the wavenumber difference a discrepancy Δv̅_{Raman} expressed in relative wavenumber (in cm⁻¹) corresponds to the Raman displacement or also Raman shift, λ_{exc} corresponds to the excitation wavelength and λ_{obs} corresponds to a wavelength in the observation spectral range. λ_{exc} and λ_{obs} being expressed in nm. The negative values of Δv̅_{Raman} correspond to the anti-Stokes Raman scattering and the positive values of Δv̅_{Raman} correspond to the Stokes Raman scattering.

In the case of the n-photon hyper Raman configuration, the relative wavenumber is hence formed by the difference between an integer multiple of the excitation wavenumber and the observation wavenumber:

Δv̅_{Raman}=n.v̅_{exc}−v̅_{obs}, with n≥2. (3)

A Raman displacement or Raman shift spectral domain, hereinafter called Raman spectral domain, expressed in relative wavenumber, is defined.

Device and Method

FIG. 1 proposes a schematic representation of the elements of a Raman spectrometry device 1 according to the invention.

The Raman spectrometry device 1 comprises a source system 2, an optional polarization device 4, an optional optical guiding and/or focusing and/or collimation and/or beam shaping system 3. a spectral separation system 8. a detection filter 9, a detection system 10 and a calculator 12. The Raman spectrometry device 1 is intended to characterize a sample 6.

The source system 2 is adapted to generate an incident excitation light beam at at least one first excitation wavelength, denoted λ_{exc}_{₁}, and at a second excitation wavelength λ_{exc}_{₂}. In an exemplary embodiment, the source system 2 comprises a plurality of monochromatic laser sources 21, 22. The first laser source 21 generates an excitation light beam at the first excitation wavelength λ_{exc}_{₁}, corresponding to a first excitation wavenumber

$${\overline{v}}_{e x {c}_{1}} = \frac{1 {0}^{7}}{{λ}_{e x {c}_{1}}} .$$

The second laser source 22 generates an excitation light beam at the second excitation wavelength λ_{exc}_{₂}, corresponding to a second excitation wavenumber

$${\overline{v}}_{e x {c}_{2}} = \frac{1 {0}^{7}}{{λ}_{e x {c}_{2}}} .$$

In this case of plurality of monochromatic laser sources, the Raman spectrometry device 1 comprises a source selector or combiner 20. As an alternative, the source system 2 comprises a wavelength-tunable laser source. As another alternative, the source system 2 comprises a plurality of wavelength-tunable sources. As another alternative, the source system 2 comprises a selectable multi-wavelength source. The source system 2 generates a continuous or pulsed incident excitation light beam.

Optionally, the Raman spectrometry device 1 includes a polarization device 4. The polarization device 4 can be integrated into the source system 2 or separated from the source system 2. This polarization device 4 is described hereinafter, in relation with the application to the Raman Optical Activity (ROA) measurement.

Advantageously, the Raman spectrometry device 1 includes an optical guiding and/or collimation and/or focusing and/or beam shaping system 3. The optical system 3 can be at least partly integrated into the source system 2 or separated from the source system 2. The incident excitation light beam is directed towards the optical guiding and/or collimation and/or focusing and/or beam shaping system 3. The optical system 3 is configured to direct and adapt the light beam to the sample 6.

In practice, the optical system 3 can comprise a set of lenses and/or mirrors and/or an optical fibre and/or also a set of optical fibres. Preferably, the optical fibre that is used is a hollow fibre that allows limiting the spurious signals during the transmission of the light beam. The optical system 3 can comprise a confocal optical device with a mirror and/or microscope lens.

The incident excitation light beam at the first excitation wavelength is scattered by the sample 6 and generates a first scattered light beam. In the whole description, the expression “light beam scattered by the sample” will also take into account the case of the light beams scattered whatever the direction of observation, in particular the example of the light beams backscattered by opaque samples, for example. Similarly, the incident excitation light beam at the second excitation wavelength is scattered by the sample and generates a second scattered light beam.

An optical collection system 7 can allow collecting the light beam scattered by the sample 6. In the case of backscattered light beams, the optical collection system 7 can be merged with the optical guiding and/or collimation and/or focusing and beam shaping system 3.

The Raman spectrometry device 1 comprises a spectral separation system 8 adapted to receive and spectrally separate the light beam scattered by the sample 6. In an exemplary embodiment, the spectral separation system 8 comprises a spectrometer based on diffraction grating(s) or a spectrometer based on prism(s) or a spectrometer based on grism(s) or also a spectrometer comprising a combination of diffraction grating(s) and/or prism(s) and/or grism(s). The light beam scattered by the sample 6 is hence spatially dispersed into its different wavelengths.

In another exemplary embodiment, the spectral separation system 8 can also comprise one or several band-pass or interferential filters and/or an acousto-optic tunable filter (AOTF) and/or an interferometer generally limited in spectral domain. In the case of an interferometer, the different wavelengths of the scattered light beam are separated by an interferometer.

The Raman spectrometry device 1 also comprises at least one detection filter 9, arranged between the sample and the spectral separation system 8 on the path of the first, respectively second, scattered light beam. The filter 9 is generally placed after the collection optical system 7. This filter 9 cuts-off the first excitation wavelength λ_{exc}_{₁} and the second excitation wavelength λ_{exc}_{₂}, hence suppressing the Rayleigh scattering of said scattered light beams. This filter 9 lets all the wavelengths of the observation spectral range pass through. The use of the filter 9 is different from the devices known from the prior art in which is preferentially used a notch filter, a narrow-band filter (of the order of a few nanometres) centred on a determined excitation wavelength in order to remove it from the collected signal.

In an exemplary embodiment, the filter 9 can be a high-pass filter for the observation of the Stokes Raman scattering. In this case, the filter has a cut-off wavelength strictly located between the highest excitation wavelength, for example) λ_{exc}_{₁}, and the lowest observation wavelength λ_{obs}_{₁}. In another exemplary embodiment, the filter 9 can be a low-pass filter for the observation of the anti-Stokes Raman scattering. In still another example, the filter 9 can be a band-pass filter for the simultaneous observation of the Stokes and anti-Stokes Raman scatterings. In the case of the simultaneous observation of the Stokes and anti-Stokes Raman scatterings, an additional filter, of the notch type centred on the excitation wavelength, is used to filter the excitation wavelength in question. Such a notch filter only makes it possible to block the excitation wavelength in the observation spectral range. For excitation wavelengths outside the observation spectral range, it is just required to cut-off all the wavelengths outside the observation spectral range. A notch filter can also be used only to limit the brightness at the detection system.

The first, respectively second, spectrally separated light beam is directed towards the detection system 10. Preferably, the observation spectral range of the detection system 10 is fixed. This observation spectral range extends between a first observation wavelength λ_{obs}_{₁} and a second observation wavelength λ_{obs}_{₂}. For example, the observation spectral range can extend between λ_{obs}=790 nm and λ_{obs}_{₂}=920 nm. The known prior-art Raman spectrometry devices using a fixed spectral separation system are generally configured to acquire measurements over the widest possible wavelength spectrum. According to the configuration of the invention, the width of the observation spectral range is relatively narrow, for example herein of 130 nm.

In an exemplary embodiment with a diffraction grating-based spectrometer, the detection system 10 includes a one-dimensional linear detector or a two-dimensional array detector, for example a camera of the CCD or CMOS type for a detection in the visible and the near infrared or also of the InGaAs or MCT type for a detection in the infrared.

In still another exemplary embodiment, the spectral separation system 8 includes an interferential filter, possibly combined with a band-pass filter. In this case, the detection system 10 then includes a detector allowing a time tracking of the interfering signal on this detector. By time tracking of the signal, it is meant an interferential system in which a mirror is displaced as a function of time to observe the interference fringes. The Raman spectrum in relative wavenumber is reconstructed by a Fourier transform based on the interferogram.

The detection system 10 generally comprises a detector that makes it possible to convert into electrons the photons it receives from the scattered beam and to accumulate these electrons. The detection system 10 usually comprises an analog-to-digital converter adapted to count the accumulated electrons and to convert these measurements into numerical values. The detection system 10 hence records as numerical values a first, respectively second, Raman scattered signal, hereinafter called Raman signal, associated with the first, respectively second, scattered light beam spectrally separated by the spectral separation system 8 in a chosen observation spectral range.

A calculator 12 is adapted to receive the first, respectively second, Raman signal recorded as numerical values. Generally, the calculator 12 is adapted to generate a first, respectively second, spectrum of the Raman signal, also called Raman spectrum part hereinafter, depending on the excitation wavelength and on the chosen observation spectral range, expressed in wavelength [λ_{obs}_{₁}, λ_{obs}_{₂}].

The calculator 12 is adapted to calculate a first, respectively second, Raman scattering spectrum part as a function of the relative wavenumber calculated with respect to the first excitation wavenumber v̅_{exc}_{₁}, respectively second excitation wavenumber v̅_{obs}_{₂}, associated with the incident excitation light beam. This first, respectively second, Raman spectrum part is calculated in a first, respectively second, Raman spectral domain, expressed in relative wavenumber, that is function of the excitation wavenumber and of the observation spectral range, expressed in wavenumber [v̅_{obs}_{₂}, v̅_{obs}_{₁}]. For the first excitation wavelength the first Raman spectral domain extends between a first relative wavenumber Δv̅₁ corresponding to the difference between the first excitation wavenumber v̅_{exc}_{₁} and the maximum observation wavenumber v̅_{obs}_{₁} and a second relative wavenumber Δv̅₂ corresponding to the difference between the first excitation wavenumber v̅_{exc}_{₁} and the minimum observation wavenumber v̅_{obs}_{₂}. For the second excitation wavelength λ_{exc}_{₂}, the second Raman spectrum domain extends between a third relative wavenumber Δv̅₃ corresponding to the difference between the second excitation wavenumber v̅_{exc}_{₂} and the maximum observation wavenumber v̅_{obs}_{₁} and a fourth relative wavenumber Δv̅₄ corresponding to the difference between the second excitation wavenumber v̅_{exc}_{₂} and the minimum observation wavenumber v̅_{obs}_{₂}. In other words, the calculator converts the first, respectively second, Raman signal expressed in wavelength into a first, respectively second, Raman spectrum part expressed in relative wavenumber. The first Raman spectral domain and the second Raman spectral domain are different in relative wavenumber. The first Raman spectral domain and the second Raman spectral domain can be disjoint or can partially overlap each other.

The known prior art Raman spectrometry devices generally use a single excitation wavelength and adapt the spectral separation system and/or the detection system to allow obtaining a Raman spectrum expressed as a function of the widest possible relative wavenumber. On the contrary, in the configuration of the invention, different excitation wavelengths are used in combination, preferably, with a single detection filter or possibly, in certain cases, with several detection filters. The detection filter(s) can remain fixed despite the change of excitation wavelength. A relatively narrow observation spectral range then makes it possible to obtain as many different Raman spectrum parts over different spectral domains expressed in relative wavenumber as there are excitation wavelengths, which then make it possible to reconstitute a Raman spectrum that is extended and/or that has possibly a high spectral resolution by adapting the spectral separation system 8. The device according to the invention also makes it possible to obtain a few specific Raman spectrum parts with a high spectral resolution and/or spaced apart from each other in relative wavenumber.

The above-described Raman spectrometry device 1 makes it possible to implement the following method for characterizing a sample by Raman spectrometry.

According to the method of the invention, the source system 2 generates a first incident excitation light beam at a first excitation wavelength λ_{exc}_{₁} that corresponds to a first excitation wavenumber v̅_{exc}_{₁}. For example, it may be chosen as first excitation wavelength λ_{exc}_{₁}=785 nm, as in the first example shown in FIG. 2 (at the top).

The first incident excitation light beam is directed towards the optical guiding and/or collimation and/or focusing and/or beam shaping system 3 before being scattered by the sample 6 to be characterized. A first scattered light beam, formed by scattering of the first incident excitation light beam on the sample 6, propagates after the sample 6 towards the detection filter 9. Advantageously, this filter 9 blocks the first excitation wavelength λ_{exc}_{₁}, hence suppressing the Rayleigh scattering.

The first scattered light beam is then directed towards the spectral separation system 8 that generates a first spectrally separated scattered light beam.

The first spectrally separated scattered light beam is analysed by the detection system 10. The detection system 10 records a first Raman signal associated with the first scattered light beam. This first Raman signal is detected in an observation spectral range expressed in wavelength. This observation spectral range extends between a first observation wavelength λ_{obs}_{₁} and a second observation wavelength λ_{obs}_{₂}. Equivalently, the observation spectral range can be expressed in wavenumber, with v̅_{obs}_{₁} the first observation wavenumber and v̅_{obs}_{₂} the second observation wavenumber. The filter 9 lets all the wavelengths contained in this observation spectral range pass through and blocks the excitation wavelengths. As a variant, a complementary filter is used in order to further filter each excitation wavelength and to avoid potential spurious signals at the detection system 10. For example, in FIGS. 2 and 3, the observation spectral range defined by the spectral separation system 8 extends between 790 nm and 920 nm. In FIG. 2, the detection filter 9 is materialized by a dotted line.

Generally, the calculator 12 determines a first Raman spectrum, expressed in wavelength, from the first Raman signal in the observation spectral range, in the example of FIGS. 2 and 3, between 790 nm and 920 nm.

The calculator 12 generates a first Raman spectrum part expressed as a function of the relative wavenumber Δv̅_{Raman}, itself function of the first excitation wavenumber v̅_{exc}_{₁} and of the observation spectral range (in the examples of FIGS. 2 and 3, between 790 nm and 920 nm). In other words, the calculator converts the first Raman signal expressed in wavelength into a first Raman spectrum part expressed in relative wavenumber. The first Raman spectrum part extends between a first relative wavenumber Δv̅₁=v̅_{exc}_{₁}−v̅_{obs} _{₁} and a second relative wavenumber Δv̅₂=v̅_{exc}_{₁}−v̅_{obs}_{₂}. For example, in FIGS. 2 and 3, for a first excitation wavelength λ_{exc}_{₁} of 785 nm, for an observation spectral range comprised between 790 nm and 920 nm, the first Raman spectral domain extends from Δv̅₁=81 cm⁻¹ to Δv̅₂=1869 cm⁻¹.

The source system 2 is adapted to generate a second incident excitation light beam at a second excitation wavelength λ_{exc}_{₂} corresponding to a second excitation wavenumber v̅_{exc}_{₂}. Said second excitation wavelength is different from the first excitation wavelength, λ_{exc}_{₂}≠λ_{exc}_{₁}. For example, it may be chosen as second excitation wavelength λ_{exc}_{₂}=690 nm, as in the second example shown in FIGS. 2 and 3 (second line from the top of FIGS. 2 and 3). Advantageously, the difference between the first excitation wavelength and the second excitation wavelength is comprised between a few nm and a few hundreds of nm.

As for the first incident excitation light beam, the second incident excitation light beam is directed towards the optical guiding and/or collimation and/or focusing and/or beam shaping system 3 then towards the sample 6 to be characterized. A second scattered light beam is formed by scattering, by the sample 6, of the second incident excitation light beam.

As for the first scattered light beam, the second scattered light beam is then filtered by the detection filter 9 then separated by the spectral separation system 8, and finally directed towards the detection system 10. This detection system 10 measures and records a second Raman signal associated with the second scattered and spectrally separated light beam. This second Raman signal is detected in the same observation spectral range expressed in wavelength, which extends for the examples of FIGS. 2 and 3 between 790 nm and 920 nm. The detection system 10 then converts the Raman signals as numerical values.

The calculator 12 then calculates a second Raman spectrum part associated with the second scattered signal in a second Raman spectral domain, expressed in relative wavenumber Δv̅_{Raman} as a function of the second excitation wavenumber v̅_{exc}_{₂} and of the observation spectral range expressed in wavenumber. The spectral domain of this second Raman spectrum part extends between a third relative wavenumber Δv̅₃=v̅_{exc}_{₂}−v̅_{obs}_{₁} and a fourth relative wavenumber Δv̅₄=v̅_{exc}_{₂}−v̅_{obs}_{₂}. For example, in FIGS. 2 and 3, for a second excitation wavelength λ_{exc}_{₂} of 690 nm, in the observation spectral range comprised between 790 nm and 920 nm, the second Raman spectral domain extends from Δv̅₃=1835 cm⁻¹ to Δv̅₄=3623 cm⁻¹. In other words, the calculator converts the second Raman signal expressed in wavelength into a second Raman spectrum part expressed in relative wavenumber.

According to a variant, the calculator 12 holds the first Raman scattering spectrum part and the second Raman scattering spectrum part to constitute a set of Raman spectrum parts able to be processed later. It can also hold in this set the information relating to the excitation wavelength and the observation domain(s) expressed in wavelength. The different Raman spectrum parts that are held are for example held as vectors comprising the wavelength, the wavenumber, the intensity and the background signal intensity.

Advantageously, the calculator 12 combines the first Raman scattering spectrum part and the second Raman scattering spectrum part to reconstitute a Raman scattering spectrum over a spectral domain that is extended in relative wavenumber (see the example illustrated in FIGS. 11-12) and/or over a spectral domain with an increased spectral resolution (see the example illustrated in FIGS. 13-14).

This combination is performed in different manners. It can be performed by the raw assembly of the first Raman scattering spectrum part and the second Raman scattering spectrum part so as to form a single Raman scattering spectrum. This obtained scattering spectrum can be continuous or discontinuous, depending on the continuity or discontinuity of the spectral domains of the sampled Raman scattering spectrum parts.

As a variant, a correction can be brought to the different Raman scattering spectrum parts before their assembly. The correction can relate to a compensation for a background signal by subtracting the background signal from the signal associated with each Raman scattering spectrum part. It can also be an intensity correction of the Raman scattering spectrum parts by taking into account the detection system 10 (previously calibrated with a test sample), the energy associated with the source system 2, the size of the focal point of the source system 2 at an observation point, the volume or the surface area of the sample 6 to be characterized or also the excitation wavelength. For example, in the case of a correction of the intensity as a function of the volume of the sample 6 to be characterized, the signal associated with the corrected spectrum is obtained by dividing the signal associated with each Raman scattering spectrum part and corrected from the background signal by the volume of the sample 6. It is observed a gain in intensity as a function of the signal obtained at a new excitation wavelength λ_{f} with respect to a reference excitation wavelength λᵢ that is expressed as follows: λᵢ_{₄}/λ_{f}⁴. The Raman spectrum part obtained at the excitation wavelength λ_{f} can hence be corrected with respect to the Raman spectrum part obtained at the excitation wavelength λᵢ using the above-mentioned gain factor. As a variant, when an overlapping is observed between the first Raman scattering spectrum part and the second Raman scattering spectrum part, a mean of the two Raman scattering spectrum parts is calculated and used for the final spectrum in the overlapping area.

As an alternative, in the overlapping area, the Raman scattering spectrum part having the best signal to noise ratio can be use. Out of the overlapping area, each Raman scattering spectrum part is held, corrected or not according to the previously introduced possibilities.

This combination of the different Raman scattering spectrum parts has for advantage to reconstitute a Raman scattering spectrum over a spectral domain that is extended in relative wavenumber. FIGS. 11 and 12 show for example that, during the use of three excitation wavelengths of 532 nm, 561 nm and 633 nm in combination with a same spectral separation and detection system limited to a spectral domain extending from 630 nm to 740 nm, the reconstituted Raman scattering spectrum (also called extended Raman spectrum or composite multispectral Raman spectrum) obtained by the combination of three Raman spectrum parts extends over a spectral domain expressed in relative wavenumber comprised between 100 cm⁻¹ and 5200 cm⁻¹.

The combination of the Raman scattering spectrum parts according to the invention has also for advantage to improve the spectral resolution in a determined Raman spectral domain. FIGS. 13 and 14 show that the use of a spectral separation system with a diffraction grating of finer pitch, for example of 1200 or 1800 lines/mm, associated with the use of several excitation wavelengths, makes it possible to improve the spectral resolution of the Raman scattering spectrum parts. The spectral domain over which extends the reconstituted Raman scattering spectrum remains relatively extended even if it can show certain discontinuities. In relation with FIGS. 13 and 14, a conventional Raman system based on the use of an excitation wavelength of 633 nm, a dispersion system based on a diffraction grating of 600 lines/mm and a detection system extending between 635 nm and 1003 nm are considered. The detection system detects for example N pixels between 635 nm and 1003 nm. This system makes it possible to obtain a Raman spectrum extending between 100 cm⁻¹ and 5828 cm⁻¹ but requires a near infrared spectrometer. FIGS. 13 and 14 show for example the use of a diffraction-grating spectral separation system, for example of 1200 lines/mm, wherein, with a first excitation wavelength of 633 nm, a first spectrum part is acquired between 635 nm and 798 nm, and with a second excitation wavelength of 561 nm, a second spectrum part is acquired in the same spectral window between 635 nm and 798 nm. In other words, a first Raman spectrum part extending in wavenumber between 100 cm⁻¹ and 3266 cm⁻¹ and a second Raman spectrum part extending in wavenumber between 2127 cm⁻¹ and 5294 cm⁻¹ are acquired. The reconstituted Raman scattering spectrum obtained by the combination of the first and second Raman spectrum parts extends over a spectral domain then extending in relative wavenumber between 100 cm⁻¹ and 5294 cm⁻¹, with a spectral resolution that is approximately twice that obtained with the single excitation wavelength of 633 nm, the diffraction grating of 600 lines/mm while using a detection system that is narrower in wavelength with a better detectivity over the domain, herein in the visible, hence more standard and less expensive.

Similarly, FIGS. 13-14 show for example the use of a diffraction-grating spectral separation system, for example of 1800 lines/mm with three excitation wavelengths of 633 nm, 561 nm and 532 nm. With a first excitation wavelength of 633 nm, a first spectrum part is acquired between 635 nm and 718 nm, with a second excitation wavelength of 561 nm, a second spectrum part is acquired in the same spectral window between 635 nm and 718 nm and, with a third excitation wavelength of 532 nm, a third spectrum part is acquired in the same spectral window between 635 nm and 718 nm. In other words, a first Raman spectrum extending in wavenumber between 100 cm⁻¹ and 1870 cm⁻¹, a second Raman spectrum extending in wavenumber between 2127 cm⁻¹ and 3898 cm⁻¹ and a third Raman spectrum extending in wavenumber between 3098 cm⁻¹ and 4869 cm⁻¹, are acquired. The reconstituted Raman scattering spectrum (also called composite multispectral Raman spectrum) obtained by the combination of the first, second and third Raman spectrum parts extends over a spectral domain extending in relative wavenumber between 100 cm⁻¹ and 1870 cm⁻¹ and between 2127 cm⁻¹ and 4869 cm⁻¹ with a spectral resolution that is approximately three times that obtained with a single excitation wavelength of 633 nm, a diffraction grating of 600 lines/mm and using an observation domain or a detection system that is more limited in wavelength, herein in the visible, hence more simple, more efficient and less expensive.

The known Raman spectrometry devices generally use a single source, at a single fixed excitation wavelength. It is then obtained at one time a Raman spectrum that is the most extended possible in relative wavenumber [Δv̅ₘᵢₙ, Δv̅ₘₐₓ]. The other known configuration uses a mobile spectral separation system, for example based on a mobile diffraction grating, and makes it possible to obtain in several times a Raman spectrum that is better resolved and more extended. Hence, for the observation towards the high wavenumbers, it is, in certain cases, in particular for the Raman Optical Activity (ROA, presented hereinafter in the present description), necessary to displace or modify the spectral separation system but also to correct all the optical adjustments and to adapt the polarization analyser for the observation of the high wavenumbers. The method of the invention allows obtaining an extended Raman spectrum towards the high wavenumbers by modifying only the excitation wavelength of the incident light beam: each excitation wavelength generates a Raman spectrum part in a spectral domain that is different in relative wavenumber. A chosen set of these different Raman spectrum parts makes it possible to reconstitute the extended Raman spectral domain. Particularly advantageously, according to the present disclosure, the detection filter 9, the polarization device, the polarization analyser and the spectral separation system 8 can remain fixed. This same extended reconstituted Raman spectrum domain can be obtained with a higher spectral resolution in relative wavenumber, by increasing the resolution of the original spectral separation system.

The source system 2 can be adapted to generate more than two incident excitation light beams. In the examples of FIGS. 2 and 3, five incident excitation light beams at five excitation wavelengths, of 785 nm, 690 nm, 633 nm, 532 nm and 488 nm, respectively, are generated either sequentially, or simultaneously, but spatially shifted on a two-dimensional detection system. The method applied to each of the different excitation wavelengths makes it possible to generate five Raman spectrum parts function of the relative wavenumber (or Raman displacement Δv̅_{Raman}) of the observation spectral range at each incident excitation light beam (v̅_{exc}) FIG. 2 shows that, according to an exemplary embodiment, the detection filter 9 remains unchanged when the excitation wavelengths are modified. As a variant, the detection filter 9 changes as a function of the excitation wavelength. As shown in FIG. 2, these are the specificities of the instrumental configuration combining different excitation wavelengths, at least one detection filter 9 and a preferably fixed observation spectral range, that make it possible to observe an extended Raman spectral domain, decomposed into parts, or as another choice, to observe rapidly Raman spectral domains spaced apart from each other with a high spatial resolution.

The Raman spectral domains associated with these spectrum parts extend respectively for the five excitation wavelengths of the above example: between 81 cm⁻¹ and 1869 cm⁻¹, between 1835 cm⁻¹ and 3623 cm⁻¹, between 3140 cm⁻¹ and 4929 cm⁻¹, between 6138 cm⁻1 and 7928 cm⁻¹, and between 7833 cm⁻¹ and 9623 cm⁻¹. The use of a plurality of incident excitation wavelengths makes it possible to reconstitute an extended spectral domain towards the high wavenumbers. FIG. 3 shows the different spectrum parts that allow reconstituting a Raman spectral domain, expressed in relative wavenumber, between 80 cm⁻¹ and 9623 cm⁻¹. FIGS. 13 and 14 show the different spectrum parts that allow reconstituting a Raman spectral domain, expressed in relative wavenumber, between 100 cm⁻¹ and 5828 cm⁻¹.

The measurements performed towards the high wavenumbers allow in particular the observation of the combination modes, the stretching modes CH, NH and OH, but also the harmonic modes (or “overtones”, as sometimes used) in these high frequencies, and that with an increased efficiency in our exemplary embodiment, because the Raman intensity is proportional to the power of 4 of the inverse of the excitation wavelength, and hence increases at the time of a shift from the red to the blue, i.e. towards the shorter wavelengths. That is also the case for harmonic modes of higher order in the very high frequencies.

Another example of reconstituted Raman spectral domain is proposed in the following Table I. In this example, the observation spectral range extends between 535 nm and 615 nm. The width of the observation spectral range of 80 nm is herein lower than 100 nm. The source system 2 is adapted to generate sequentially five excitation wavelengths, of 633 nm, 561 nm, 532 nm, 488 nm and 473 nm, respectively. The lower and upper limits of each Raman spectral domain expressed in relative wavenumber are calculated from the above-mentioned formula (1). The following Tables I and II sum up the Raman spectral domains expressed in relative wavenumber obtained for two observation spectral ranges, between 535 nm and 615 nm for Table I and between 790 nm and 920 nm for Table II:

TABLE I

| | Δν̅ₘᵢₙ (cm⁻¹) | Δν̅ₘₐₓ (cm⁻¹) | |
|---|---|---|---|
| λ_{exc} | for | for | |
| (nm) | λ_{obs1} = 535 nm | λ_{obs2} = 615 nm | Applications |
| 633 | −2894 | −462 | Anti-Stokes scattering spectral |
| | | | fingerprint domain, coherent |
| | | | anti-Stokes Raman scattering, |
| | | | with low-pass filter |
| 561 | −866 | 1565 | Low frequency Stokes and |
| | | | anti-Stokes scattering, |
| | | | with notch filter |
| 532 | 105 | 2537 | Spectral fingerprint domain |
| 488 | 1800 | 4232 | Extension for ν̅_{OH}, ν̅_{NH} and |
| | | | ν̅_{CH} with an overlapping area |
| 473 | 2450 | 4881 | Extension for ν̅_{OH}, ν̅_{NH} and |
| | | | ν̅_{CH}, combination modes |
| | | | and harmonic modes |

TABLE II

| | Δν̅ₘᵢₙ (cm⁻¹) | Δν̅ₘₐₓ (cm⁻¹) | |
|---|---|---|---|
| λ_{exc} | for | for | |
| (nm) | λ_{obs1} = 790 nm | λ_{obs2} = 920 nm | Applications |
| 1064 | −3260 | −1471 | Anti-Stokes scattering, coherent |
| | | | anti-Stokes Raman scattering, |
| | | | combination modes and ν̅_{CH} |
| 914 | −1717 | 71 | Anti-Stokes scattering, coherent |
| | | | anti-Stokes Raman scattering |
| 785 | 81 | 1869 | Spectral fingerprint domain |
| 690 | 1835 | 3623 | Overlapping area, combination |
| | | | modes, ν̅_{NH} and ν̅_{CH} |
| 633 | 3140 | 4929 | Extension for ν̅_{OH}, ν̅_{NH} and |
| | | | ν̅_{CH}, combination modes |
| | | | and harmonic modes |

FIG. 4 shows an example of Raman scattering spectrum part for the Stokes configuration obtained using the above-described Raman spectrometry method. The ordinate axis corresponds to the intensity of the electronic signal recorded by the detection system, in arbitrary units (a.u.). The abscissa axis corresponds to the observation wavelength (in nm). The different curves are associated with different excitation wavelengths, of 700 nm, 710 nm, 720 nm, 730 nm, 740 nm and 750 nm, respectively. The observation spectral range herein extends between 760 nm and 880 nm. The width of the observation spectral range is herein also relatively narrow, limited to 120 nm. These different Raman spectrum parts of the acetonitrile have been obtained with a diffraction-grating spectral separation system, for example of 830 lines/mm, and a detection system comprising a CCD camera, for example of 2048 pixels.

FIG. 5 shows an example of Raman scattering spectrum parts, for the Stokes configuration, expressed in relative wavenumber, corresponding to the wavelength spectra of FIG. 4. The ordinate axis corresponds to the intensity of the electronic signal recorded by the detection system in arbitrary units (a.u.). The abscissa axis corresponds to the Raman displacement in relative wavenumber (in cm⁻¹). Each spectrum part shown in FIG. 5 corresponds to a spectrum shown in

FIG. 4. The spectrum parts of FIG. 5 are generated by the calculator in Raman displacement, expressed in relative wavenumber, for the same observation spectral range as that of FIG. 4 with respect to the different excitation wavelengths. The configuration of the spectral separation system and of the detection system remains identical for all the excitation wavelengths. The spectral domain of all the Raman spectrum parts herein extends from about 0 cm⁻¹ to 2800 cm⁻¹.

FIG. 11 shows another example of Raman scattering spectrum parts obtained using the above-described Raman spectrometry method. The different curves are associated with different excitation wavelengths, of 633 nm, 561 nm and 532 nm, respectively. The observation spectral range herein extends between 630 nm and 740 nm. The width of the observation spectral range is herein also relatively narrow, limited to 110 nm. These different Raman spectrum parts of the alpha-pinene have been obtained with a diffraction-grating spectral separation system, for example of 600 lines/mm.

FIG. 12 shows an example of Raman scattering spectrum parts, expressed in relative wavenumber, corresponding to the wavelength spectra of FIG. 11. Each spectrum part shown in FIG. 12 corresponds to a spectrum shown in FIG. 11.

The spectrum parts of FIG. 12 are generated by the calculator in Raman displacement, expressed in relative wavenumber, for the same observation spectral range as that of FIG. 11 with respect to the different excitation wavelengths. More precisely, a first Raman spectrum part obtained with the excitation wavelength of 633 nm extends between 100 cm⁻¹ and about 2300 cm⁻¹; a second Raman spectrum part obtained with the excitation wavelength of 561 nm extends between 2100 cm⁻¹ and about 4300 cm⁻¹, and a third Raman spectrum part obtained with the excitation wavelength of 532 nm extends between about 3000 cm⁻¹ and 5300 cm⁻¹. The configuration of the spectral separation system and of the detection system remains identical for all the excitation wavelengths. The spectral domain of the set of Raman spectrum parts herein extends from about 0 cm⁻¹ to 5300 cm⁻¹.

In another example (not illustrated), the use of four excitation wavelengths of 785 nm, 685 nm, 633 nm and 561 nm makes it possible to obtain four Raman spectrum parts of the chloroform, and the calculator makes it possible to hold this set of four Raman scattering spectrum parts to process it later or to combine these four Raman spectrum parts to reconstitute a Raman spectrum extending from 100 cm⁻¹ to 7000 cm⁻¹.

FIGS. 6 and 7 show Raman spectrum examples for the anti-Stokes configuration, as a function of the observation wavelength for FIG. 6 and as a function of the relative wavenumber for FIG. 7.

In FIGS. 6 and 7, the ordinate axis corresponds to the intensity of the Raman signal recorded by the detection system, in arbitrary units (a.u.). These spectra have been obtained for an observation spectral range extending between 660 nm and 780 nm, with a diffraction-grating spectral separation system, for example of 830 lines/mm, and a detection system comprising a CCD camera, for example of 2048 pixels. The width of the observation spectral range is herein also relatively narrow, limited to 120 nm. The different curves are associated with different excitation wavelengths, of 788 nm, 800 nm, 820 nm and 850 nm, respectively.

As a variant, the Raman spectrometry device 1 can be used to measure non-linear Raman effects such as the Hyper Raman, the stimulated Raman and the coherent anti-Stokes Raman scattering (CARS). For example, the Raman spectrometry device 1 makes it possible to measure the 2-photon or more generally n-photon Hyper Raman effect, where n is a natural integer higher than or equal to 2. In this configuration, the source system 2 generates an incident excitation light beam at an excitation wavelength denoted λ_{exc}. The calculator 12 is adapted to generate a Raman spectrum part in an observation spectral range, said observation spectral range extending near a wavelength corresponding to a fraction 1/n of the excitation wavelength λ_{exc}, for example to half the excitation wavelength in the case where n=2. Optionally, an additional filter is arranged in the device between the sample 6 and the detection system 10, to cut off the wavelength corresponding to this fraction 1/n of the excitation wavelength. The calculator 12 is adapted to generate a 2-photon Hyper Raman spectrum part in a spectral domain expressed in relative wavenumber:

Δv̅_{Raman}=2*v̅_{exc}−v̅_{obs} (4)

The relative wavenumber for the 2-photon Hyper Raman signal is herein equal to the difference between twice the excitation wavenumber and the observation wavenumber. Here also, the relative wavenumber is hence formed of a linear combination of the excitation wavenumber and of the observation wavenumber.

FIG. 8 shows an example of Hyper Raman scattering spectra obtained using the variant of the Raman spectrometry method described in the previous paragraph. The ordinate axis corresponds to the intensity of the Raman signal recorded by the detection system, in arbitrary units (a.u.). The abscissa axis corresponds to the observation wavelength (in nm). The different curves are associated with different excitation wavelengths, of 1160 nm, 1180 nm, 1210 nm, 1240 nm, 1270 nm et 1300 nm, respectively. The observation spectral range herein extends between 635 nm and 705 nm. The width of the observation spectral range is herein limited to about 70 nm for most of the spectra. As a complement, a Raman spectrum of about 200 nm is shown for a spectrum at the excitation wavelength of 1300 nm, by turning the diffraction grating. These different spectra have been obtained with a diffraction-grating spectral separation system, for example of 1800 lines/mm and a detection system comprising a CCD camera, for example of 2048 pixels.

FIG. 9 shows an example of Hyper Raman scattering spectrum parts expressed in relative wavenumber. The ordinate axis corresponds to the intensity of the electronic signal recorded by the detection system, in arbitrary units (a.u.). The abscissa axis corresponds to the Raman displacement in relative wavenumber (in cm⁻¹) in the two-photon Hyper Raman configuration (deduced from Formula (3)). The spectrum parts shown in FIG. 9 correspond to the spectra shown in FIG. 8, with a modification of the abscissa axis by conversion of the wavelengths into relative wavenumbers, the relative wavenumbers being calculated for each Raman spectrum part as a function of the excitation wavelength peculiar to each excitation light beam and of the observation wavelength in the observation spectral range that remains fixed for all the excitation wavelengths. The calculator 12 generates the spectrum parts of FIG. 9 in relative wavenumber of the observation spectral range of FIG. 8 with respect to each excitation wavelength, the configurations of the spectral separation and detection systems being identical to each other. The Raman spectral domain (deduced from Formula (3)) herein extends, in relative wavenumber, from—200 cm⁻¹ to 3300 cm⁻¹.

As another variant, the Raman spectrometry device 1 can be used to perform Raman Optical Activity (or ROA) measurements. There exist three types of basic arrangements: the ICP (Incident Circular Polarization) arrangement, the SCP (Scattered Circular Polarization) arrangement and the DCP (Dual Circular Polarization) arrangement. The sample 6 to be analysed is then either chiral, or of chiral primary or secondary structure. The measurement of the ROA spectrum is based on a difference of Raman signals coming from a polarization modulation of the incident excitation light beam and/or of the scattered light beam. FIG. 10 proposes a schematic representation of the different elements of a Raman spectrometry device 100 within the framework of Raman Optical Activity measurements. The elements that are common to FIGS. 1 and 10 are denoted by the same references and won't be described again in the following.

The source system 2 generates a first incident excitation light beam at a first excitation wavelength. The incident excitation light beam is directed towards a polarization device 4. Said polarization device 4 includes for example a polarizer and/or a prism or a half-wave or quarter-wave delay plate adapted to polarize the incident excitation light beam either according to at least two different polarization states, for example orthogonal between each other, such as for example two circular or elliptic polarization states, or according to a linear polarization of random direction perpendicular to the propagation axis simulating a non-polarized beam. The incident excitation light beam so polarized by the polarization device 4 is then directed towards the sample 6 to be characterized.

After the sample, the light beam is filtered by the detection filter 9. The Raman spectrometry device 100 further includes a polarization analyser 7 adapted to analyse the filtered light beam. The polarization analyser 7 includes a scatterer or a right and/or left circular polarization selector or a right and/or left elliptic polarization selector or a linear polarization separator located after a circular polarization-to-linear polarization converter, for example a quarter-wave plate. After the polarization analyser 7, the scattered and polarization-analysed light beam is spectrally separated by the spectral separation system 8, then directed towards the detection system 10. As a variant, the polarization analyser 7 can be positioned before the detection filter 9.

Similarly to the above-described Raman spectrometry method, the first excitation light beam at a first excitation wavelength, polarized according to a first polarization, leads to the recording of a first Raman signal.

The polarization device 4 is configured to modify the polarization state of the incident excitation and/or scattered light beam, for example first according to a left circulation polarization. According to the above-described Raman spectrometry method, a second excitation light beam at this first excitation wavelength and polarized according to a second polarization leads to the recording by the detection system 10 of a second Raman signal.

The calculator 12 is adapted to generate a third Raman signal, called Raman

Optical Activity spectrum, this third signal corresponding to the difference of the first Raman signal and the second Raman signal or, according to another configuration, to a linear combination of a set of Raman spectra of different polarizations, expressed in relative wavenumber of the excitation v̅_{exc}_{₁} with respect to the observation spectral range [v̅_{obs}_{₂}, v̅_{obs}_{₁}].

The source system 2 is adapted to generate at least two different excitation wavelengths. The method applied for each of the different excitation wavelengths makes it possible to generate at least two Raman optical activity spectrum parts as a function of the relative wavenumber of the observation spectral range with respect to the wavenumber corresponding to the incident excitation light beam, without changing the polarizing optical components. The use of multiple incident excitation wavelengths makes it possible either to reconstitute an extended spectral domain towards the high wavenumbers, or to rapidly observe Raman spectral domains that are well-resolved and spaced apart from each other. The two solutions make it possible to complete and refine the spectral characterization of the studied sample 6, for example the chirality in the case of Raman Optical Activity.

As another variant, the Raman spectrometry device 1 can be used to perform Hyper Raman Optical Activity (HROA) measurements. In this case, the spectrometry device comes as the Raman Optical Activity variant, with an excitation using two photons instead of one or using n photons if the higher-order non-linear HROA effect is observed. In the Hyper Raman (or HROA) configuration, only the excitation and the optical guiding and/or collimation and/or focusing and/or beam shaping system 3 have to be adapted for an excitation wavelength equal to twice that used in the Raman (or ROA) configuration. Potentially, an additional adapted filter may be added to cut off the excitation wavelength liable to jam the Raman system, even at a wavelength far higher than the observation domain.

As another variant, the spectral separation system 8 and/or the detection filter 9 and/or the interferential system and/or the detection system 10 is adapted to record a Raman spectrum, respectively ROA spectrum, associated with said first scattered light beam and detected in another, reduced observation spectral range, expressed in wavelength, [λ_{obs}_{₃}, λ_{obs}_{₄}], with a better resolution. By holding the same number of detection elements, another scattered signal is then detected and hence has higher accuracy and spectral resolution than the first Raman signal. The calculator 12 receives the other signal of the detection system 10 and generates another spectrum of said other scattered signal as a function of the wavelength of said other observation spectral range [λ_{obs}_{₃}, λ_{obs}_{₄}]. The calculator 12 is also adapted to generate another Raman spectrum part, expressed in relative wavenumber, that is function of the difference between the first wavenumber associated with the first excitation light beam and the wavenumbers of said reduced observation spectral range [v̅_{obs}_{₄}, v̅_{obs}_{₃}], said other spectral domain extending between a fifth relative wavenumber Δv̅₅=v̅_{exc}_{₁}−v̅_{obs}_{₃} and a sixth relative wavenumber Δv̅₆=v̅_{exc}_{₁}−v̅_{obs}_{₄}. That way, as the number of detection elements is held in the reduced spectral domain, the spectral accuracy of the obtained Raman scattering spectrum increases. In practice, the spectral accuracy increases inversely to the reduction ratio of the observation spectral range expressed in wavelength.

As another variant, a second spectral separation system (not shown) can be added on the path of the light beam after the first spectral separation system 8, which makes it possible to reduce the observation spectral range and hence to obtain very resolved Raman spectral domains expressed in relative wavenumber, typically of the order of a few tens of cm⁻¹.

As still another variant, the Raman spectrometry device 1 makes it possible to accurately and rapidly calibrate in wavelength a spectral separation system. For that purpose, the source system 2 includes a wavelength-tunable laser source, or a laser source with different selectable discrete wavelengths. The source system is originally calibrated or measured in wavelength with, for example, a lambdameter. These excitation light beams whose wavelength is determined are scattered by a reference sample having one or several narrow and well-known spectral bands. The excitation wavelength change makes it possible to scan and calibrate the spectral domain of the spectral separation system. The use of the Raman spectrometry device 1 according to the invention then makes it possible to free from the spectral calibration lamps.

The Raman spectrometry device according to the invention can relate to all the Raman spectrometers, including the portable and on-board devices, that work with a fixed observation spectral range, adapted for measurements on site, from the satellites, from the extra-terrestrial probes or in the ocean depths. For these different applications, the spectral reproducibility and the absence of mobile parts is crucial for the durability of the instruments and the measurements.

The Raman spectrometry device 1 according to the invention can also relates to the Raman spectrometers for which measurement with a high dynamics and of high signal-to-noise ratio at the high wavenumbers are desired: the observation spectral range expressed in wavelength for which the spectral separation and detection system is optimized, and that whatever the Raman domain that are sounded. In particular, it makes it possible to sound the harmonics of higher orders at the very high wavenumbers, in particular higher than 5000 cm⁻¹. In the same way, the invention also makes it possible to sound rapidly with a high resolution several narrow Raman spectral domains very distant from each other in relative wavenumbers, with these same efficiency advantages.

The present invention makes it possible to sound Stokes Raman spectral domains of relative wavenumbers far higher than the initial observation wavenumber: by way of example, if the observation is located towards 10000 nm (1000 cm⁻¹), by exciting at 1000 nm (10000 cm⁻¹), the invention makes it possible to easily measure a spectrum at very high wavenumbers towards 9000 cm⁻¹, where the third harmonics of the stretching modes CH are located.

Moreover, when the fluorescence causes interferences to the Raman spectra, usage is to favour a laser excitation in the near infrared at 785 nm and 1064 nm. Unfortunately, at these exciting wavelengths, the detection of the high wavenumbers, as the stretching modes CH (3000 cm⁻¹) and beyond, drastically drops, due to the low efficiency of the detection systems: this amounts to observe the infrared domains (respectively, 1030 nm and 1563 nm). The present invention, by keeping essentially the same observation domain in nm over at least one overlapping area and the optimized efficiency of the spectral separation system and of the detection system, makes it possible to easily measure these high relative wavenumbers while increasing the Raman effect (proportional to 1/λ_{exc}⁴) and always avoiding the fluorescence that remains confined in the same emission spectral domain in nm, whatever the exciting wavelength.

1. A Raman spectrometry device for characterizing a sample, the device comprising a source system generating a first incident excitation light beam at a first excitation wavelength, a spectral separation system receiving a first scattered light beam formed by scattering of said first incident excitation light beam on the sample and spectrally separating said first scattered light beam, a detection system making it possible to record a first Raman signal associated with said first scattered light beam and detected in an observation spectral range expressed in wavelength extending between a first observation wavelength and a second observation wavelength, a calculator receiving the first Raman signal from said detection system and generating a first Raman spectrum part as a function of the Raman displacement in a first Raman spectral domain expressed in relative wavenumber, said first Raman spectral domain extending between a first relative wavenumber that is function of the first excitation wavelength and the first observation wavelength and a second relative wavenumber that is function of the first excitation wavelength and the second observation wavelength;
wherein:
said source system is adapted to generate at least one second incident excitation light beam at a second excitation wavelength, said second excitation wavelength being different from the first excitation wavelength, said spectral separation system being adapted to receive a second scattered light beam formed by scattering of said second incident excitation light beam on the sample and to spectrally separate said second scattered light beam, said detection system being adapted to detect and record a second Raman signal associated with said second scattered light beam in the same observation spectral range expressed in wavelength, said calculator being adapted to measure the second Raman signal and to generate a second Raman spectrum part as a function of the Raman displacement in a second Raman spectral domain expressed in relative wavenumber, said second Raman spectral domain extending between a third relative wavenumber that is function of the second excitation wavelength and the first observation wavelength and a fourth relative wavenumber that is function of the second excitation wavelength and the second observation wavelength, the second Raman spectral domain being different in relative wavenumber from the first Raman spectral domain, the first Raman spectrum part and the second Raman spectrum part being intended to be combined together to reconstitute a Raman scattering spectrum over a spectral domain that is extended in relative wavenumber and/or that has an increased spectral resolution in the first and/or second Raman spectral domain.

2. The Raman spectrometry device according to claim 1, wherein the source system is adapted to generate a plurality of excitation light beams at a plurality of excitation wavelengths.

3. The Raman spectrometry device according to claim 1, wherein the source system comprises a plurality of monochromatic laser sources, an optical frequency-tunable laser source and/or a source generating several selectable or spatially separable monochromatic excitation wavelengths.

4. The Raman spectrometry device according to claim 1, wherein the source system comprises a continuous or pulsed laser source.

5. The Raman spectrometry device according to claim 1, further including at least one device for polarizing the excitation light beam between the source system and the sample, said polarization device (4) being adapted to polarize the first incident excitation light beam according to at least two different polarization states and, respectively, the second incident excitation light beam according to at least two different polarization states.

6. The Raman spectrometry device according to claim 1, further including a polarization analyser arranged between the sample and the detection system, the polarization analyser being adapted to polarization analyse and/or separate the first scattered light beam and, respectively, the second scattered light beam.

7. The Raman spectrometry device according to claim 1, wherein the calculator is configured to hold the first Raman scattering spectrum part and the second Raman scattering spectrum part and to constitute a set of Raman spectrum parts or to combine the first Raman spectrum part and the second Raman spectrum part and to reconstitute a Raman spectrum that is extended and/or that has an increased spectral resolution in relative wavenumber.

8. The Raman spectrometry device according to claim 1, wherein the calculator is adapted to generate a first, respectively second, hyper Raman scattering spectrum part in a first, respectively second, hyper Raman displacement spectral domain expressed in relative wavenumber, wherein the first relative wavenumber is equal to the difference between a product of an integer n and of the first excitation wavenumber and the first observation wavenumber, the second relative wavenumber is equal to the difference between a product of the integer n and of the first excitation wavenumber and the second observation wavenumber, the third relative wavenumber is equal to the difference between a product of the integer n and of the second excitation wavenumber and the first observation wavenumber, the fourth relative wavenumber is equal to the difference between a product of the integer n and of the second excitation wavenumber and the second observation wavenumber, the integer multiple n being higher than or equal to two.

9. The Raman spectrometry device according to claim 1, comprising a detection filter configured to cut-off the first excitation wavelength and/or the second excitation wavelength.

10. The Raman spectrometry device according to claim 1, wherein the detection filter comprises at least one high-pass filter, one low-pass filter or one band-pass filter, or a combination of said filters.

11. The Raman spectrometry device according to claim 1, wherein the spectral separation system comprises a spectrometer based on diffraction grating(s), prism(s) and/or grism(s) or a spectrometer comprising a combination of diffraction grating(s) and/or prism(s) and/or grism(s).

12. The Raman spectrometry device according to claim 1, wherein the spectral separation system comprises an interferential filter and/or an interferometer.

13. The Raman spectrometry device according to claim 1, wherein the detection filter is fixed.

14. The Raman spectrometry device according to claim 1, wherein the detection system comprise a single-channel detector or a one-dimensional linear detector or a two-dimensional array detector.

15. A Raman spectrometry method comprising the following steps:
generation of a first incident excitation light beam at a first excitation wavelength by a source system;
spectral separation of a first scattered light beam formed by scattering of the first incident excitation light beam on a sample;
recording of a first Raman signal associated with the first scattered light beam, detected in an observation spectral range expressed in wavelength extending between a first observation wavelength and a second observation wavelength;
calculation of a first Raman spectrum part as a function of the Raman displacement in a first Raman spectral domain expressed in relative wavenumber, said first Raman spectral domain extending between a first relative wavenumber that is function of the first excitation wavelength and the first observation wavelength and a second relative wavenumber that is function of the first excitation wavelength and the second observation wavelength;
generation of at least one second incident excitation light beam at a second excitation wavelength by the source system, said second excitation wavelength being different from the first excitation wavelength;
spectral separation of a second scattered light beam formed by scattering of the second incident excitation light beam on the sample;
recording of a second Raman signal associated with the second scattered light beam, detected in the same observation spectral range expressed in wavelength;
calculation of a second Raman spectrum part as a function of the Raman displacement in a second Raman spectral domain expressed in relative wavenumber, said second Raman spectral domain extending between a third relative wavenumber that is function of the second excitation wavelength and the first observation wavelength and a fourth relative wavenumber that is function of the second excitation wavelength and the second observation wavelength, the second Raman spectral domain being different in relative wavenumber from the first Raman spectral domain; and
combination of said first Raman scattering spectrum part and said second Raman scattering spectrum part to reconstitute a Raman scattering spectrum over a spectral domain that is extended in relative wavenumber and/or that has an increased spectral resolution in the first and/or second Raman spectral domain.

16. The Raman spectrometry device according to claim 2, further including a polarization analyser arranged between the sample and the detection system, the polarization analyser being adapted to polarization analyse and/or separate the first scattered light beam and, respectively, the second scattered light beam.

17. The Raman spectrometry device according to claim 2, wherein the calculator is configured to hold the first Raman scattering spectrum part and the second Raman scattering spectrum part and to constitute a set of Raman spectrum parts or to combine the first Raman spectrum part and the second Raman spectrum part and to reconstitute a Raman spectrum that is extended and/or that has an increased spectral resolution in relative wavenumber.

18. The Raman spectrometry device according to claim 2, wherein the calculator is adapted to generate a first, respectively second, hyper Raman scattering spectrum part in a first, respectively second, hyper Raman displacement spectral domain expressed in relative wavenumber, wherein the first relative wavenumber is equal to the difference between a product of an integer n and of the first excitation wavenumber and the first observation wavenumber, the second relative wavenumber is equal to the difference between a product of the integer n and of the first excitation wavenumber and the second observation wavenumber, the third relative wavenumber is equal to the difference between a product of the integer n and of the second excitation wavenumber and the first observation wavenumber, the fourth relative wavenumber is equal to the difference between a product of the integer n and of the second excitation wavenumber and the second observation wavenumber, the integer multiple n being higher than or equal to two.

19. The Raman spectrometry device according to claim 2, comprising a detection filter configured to cut-off the first excitation wavelength and/or the second excitation wavelength.

20. The Raman spectrometry device according to claim 19, wherein the detection filter is fixed.
